(19) United States
(12) Patent Application Publication
(10) Pub. No.: US 2025/0166505 A1
(43) Pub. Date: May 22, 2025

(54) CROSSWALK SAFETY SYSTEM

(71) Applicants: Hyundai Motor Company, Seoul (KR); Kia Corporation, Seoul (KR); BASE AND POWER CITY Corp., Seoul (KR)

(72) Inventors: Donguk LEE, Seoul (KR); Sungsu Park, Seoul (KR)

(73) Assignees: Hyundai Motor Company, Seoul (KR); Kia Corporation, Seoul (KR); BASE AND POWER CITY Corp., Seoul (KR)

(21) Appl. No.: 18/769,101

(22) Filed: Jul. 10, 2024

(30) Foreign Application Priority Data
Nov. 20, 2023 (KR) 10-2023-0161397

(51) Int. Cl. G08G 1/095; E01F 9/646; E01F 13/04; G08G 1/005; G08G 1/01; G08G 1/052

(52) U.S. Cl. CPC G08G 1/095; E01F 9/646; E01F 13/046; G08G 1/005; G08G 1/0116; G08G 1/0141; G08G 1/052

(57) ABSTRACT

A crosswalk safety system includes a sensor device that obtains information related to a speed of a vehicle approaching a crosswalk through a roadway and a separation distance between the vehicle and the crosswalk, a first warning device that issues a first warning to the vehicle, a second warning device that issues a second warning to the vehicle, a robot which is arranged to move between the vehicle and a pedestrian crossing the crosswalk when the separation distance between the vehicle and the crosswalk obtained through the sensor device is less than or equal to a third separation distance after issuing the second warning, and a controller.

### CROSS-REFERENCE TO RELATED APPLICATION

The present application claims priority to Korean Patent Application No. 10-2023-0161397, filed on Nov. 20, 2023, the entire contents of which is incorporated herein for all purposes by this reference.

### BACKGROUND OF THE PRESENT DISCLOSURE

### Field of the Present Disclosure

The present disclosure relates to a crosswalk safety system.

### Description of Related art

With recent technological developments, an artificial intelligence system that collects information related to urban environments has been developed. The main purpose of such artificial intelligence systems is to share collected information with users who need it.

Currently, data is collected through sensor systems fixedly installed in a city, traffic information is analyzed, and statistical data is secured based on the collected data. However, the collected data may only be used to establish long-term policies and change facilities through such analysis, and may not be utilized immediately and actively.

Meanwhile, traffic lights are generally installed at crosswalks to guide the movement of vehicles and pedestrians. The driver of a vehicle must stop the vehicle when the stop sign is turned on, but there may be cases where the traffic light is not clearly recognized visually or the driver is unable to stop the vehicle due to inattention such as drowsiness. In the instant case, when there are pedestrians on the crosswalk, it may lead to a traffic accident.

Therefore, to ensure the safety of pedestrians at crosswalks, it is necessary to develop a system which may reduce the occurrence of traffic accidents by providing immediate warnings to drivers based on collected data.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a crosswalk safety system configured for reducing the risk of traffic accidents.

According to an aspect of the present disclosure, a crosswalk safety system includes a sensor device that obtains information related to a speed of a vehicle approaching a crosswalk through a roadway and a separation distance between the vehicle and the crosswalk, a first warning device that issues a first warning to the vehicle when the speed obtained through the sensor device is equal to or greater than a first reference speed when the separation distance between the vehicle and the crosswalk is a first separation distance, a second warning device that issues a second warning to the vehicle when the speed obtained through the sensor device is equal to or greater than a second reference speed when the separation distance between the vehicle and the crosswalk is a second separation distance after issuing the first warning, a robot which is arranged to move between the vehicle and a pedestrian crossing the crosswalk when the separation distance between the vehicle and the crosswalk obtained through the sensor device is less than or equal to a third separation distance after issuing the second warning, and a controller which is electrically connected to the sensor device, the first warning device, the second warning device, and the robot to control operations of the first warning device, the second warning device, and the robot.

According to an exemplary embodiment of the present disclosure, the sensor device may include a Light Detection and Ranging (LiDAR) sensor.

According to an exemplary embodiment of the present disclosure, the crosswalk safety system may further include a traffic light arranged in an external direction of the crosswalk to transmit a traffic signal to vehicles when a direction in which the crosswalk faces the roadway is the external direction, and the sensor device may be coupled to the traffic light.

According to an exemplary embodiment of the present disclosure, the traffic light may include a plurality of traffic lights, each of which is arranged adjacent to an end portion of the crosswalk in an extension direction when a direction in which the crosswalk extends is the extension direction, the sensor device may be coupled to each of the traffic lights, and the controller may be coupled to one of the plurality of traffic lights.

According to an exemplary embodiment of the present disclosure, the first warning device may include a light source member that emits light to provide the first warning to the vehicle.

According to an exemplary embodiment of the present disclosure, the light source member may include a plurality of light source members arranged along an extension direction in an external diction of the crosswalk when a direction in which the crosswalk faces the roadway is the external direction and a direction in which the crosswalk extends is the extension direction.

According to an exemplary embodiment of the present disclosure, the second warning device may include a bollard member that is configured to protrude upwards from a ground.

According to an exemplary embodiment of the present disclosure, the bollard member may include a plurality of bollard members arranged along an extension direction in an external diction of the crosswalk when a direction in which the crosswalk faces the roadway is the external direction and a direction in which the crosswalk extends is the extension direction.

According to an exemplary embodiment of the present disclosure, the first warning device may include a light source member that emits light to issue the first warning to the vehicle, and the light source member may include a plurality of light source member arranged along the extension direction in the external direction of the crosswalk. Furthermore, the bollard member may be arranged in the external direction of the light source member.

According to an exemplary embodiment of the present disclosure, the crosswalk safety system may further include a traffic light installed in an external direction of the crosswalk to transmit a traffic signal to vehicles, and the traffic light may be arranged in the external direction of the bollard member.

According to an exemplary embodiment of the present disclosure, the second warning device may include a rack connected to a lower side of the bollard member, a pinion engaged with the rack to move the rack up or down as the pinion rotates, and a motor that rotates the pinion.

According to an exemplary embodiment of the present disclosure, the second warning device may further include a stopper that protrudes from a lower end portion of the rack toward the pinion.

According to an exemplary embodiment of the present disclosure, a surface of the bollard member in an external direction may include a curved area which is convex or concave toward the external direction when a direction in which the crosswalk faces the roadway is the external direction.

According to an exemplary embodiment of the present disclosure, the rack may be formed with a guide hole extending in a longitudinal direction of the rack, and the second warning device may further include a guide inserted into the guide hole to guide a vertical movement of the rack.

According to an exemplary embodiment of the present disclosure, the robot may be arranged in a robot movement area which is defined between the crosswalk and the light source member.

According to an exemplary embodiment of the present disclosure, the robot may move along a movement direction of the pedestrian in the external direction of the pedestrian when the pedestrian enters the crosswalk and the second warning is not issued.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a crosswalk safety system according to an exemplary embodiment of the present disclosure;

FIG. 2 is a diagram illustrating an example of a robot in a crosswalk safety system according to an exemplary embodiment of the present disclosure;

FIG. 3 is a diagram conceptually illustrating a second warning device;

FIG. 4 is a diagram illustrating a bollard member protruding upward in FIG. 3;

FIG. 5 is a diagram conceptually illustrating another example of the second warning device; and

FIG. 6 is a diagram illustrating an intersection to which a crosswalk safety system according to an exemplary embodiment of the present disclosure is applied.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the drawings, the same reference numbers will be used throughout to designate the same or equivalent elements. Furthermore, a detailed description of well-known features or functions will be ruled out in order not to unnecessarily obscure the gist of the present disclosure.

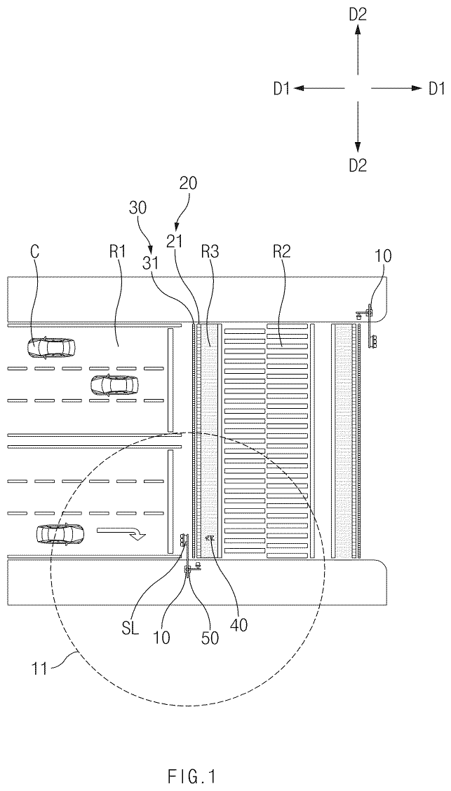

FIG. 1 is a diagram illustrating a crosswalk safety system according to an exemplary embodiment of the present disclosure.

The crosswalk safety system according to an exemplary embodiment of the present disclosure may include a sensor device 10, a first warning device 20, a second warning device 30, a robot 40, and a controller 50. The sensor device 10 may be provided to obtain information related to the speed of a vehicle C approaching a crosswalk R2 through a roadway R1 and the separation distance between the vehicle C and the crosswalk R2. As an exemplary embodiment of the present disclosure, the sensor device 10 may be a Light Detection and Ranging (LiDAR) sensor. The sensor device 10 may be provided to obtain the speed of the vehicle C within a circular sensing range 11.

The first warning device 20 may be a part that provides a primary warning to the vehicle C. The primary warning may be performed when the separation distance between the vehicle C and the crosswalk R2 is a first separation distance and the speed obtained by the sensor device 10 is higher than or equal to a first reference speed. For example, the first separation distance may be 10 m, but this may be changed by machine learning of the controller 50, which will be described later. The first reference speed may be determined based on the braking distance of the vehicle. For example, the first reference speed may be 25 km/h.

The second warning device 30 may be a part that provides a secondary warning to the vehicle C. The secondary warning may be performed when, after the primary warning, the separation distance between the vehicle C and the crosswalk R2 is a second separation distance, and the speed obtained by the sensor device 10 is higher than a second reference speed. In the instant case, the second separation distance may be smaller than the first separation distance. For example, the second separation distance may be 5 m, but this may be changed by machine learning of the controller 50, which will be described later. The second reference speed may be determined based on the braking distance of the vehicle. For example, the second reference speed may be 12.5 km/h.

After the secondary warning, the robot 40 may be provided to move between pedestrians crossing the crosswalk R2 and the vehicle C when the separation distance between the vehicle C and the crosswalk R2 obtained through the sensor device 10 is less than a third separation distance.

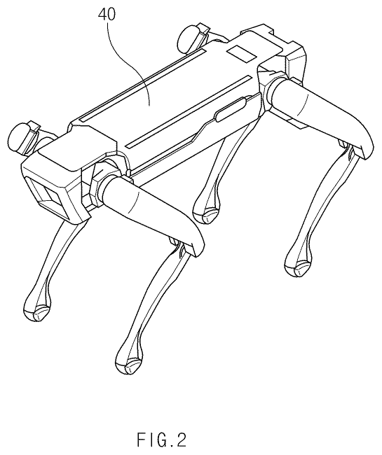

FIG. 2 is a diagram illustrating an example of a robot in a crosswalk safety system according to an exemplary embodiment of the present disclosure. As shown in FIG. 2, for example, the robot 40 may be a quadrupedal robot, but various movement schemes such as bipedal walking and movement on wheels may be possible.

In the instant case, the third separation distance may be smaller than the second separation distance. For example, the third separation distance may be 3 m, but this may be changed by machine learning of the controller 50, which will be described later.

As an exemplary embodiment of the present disclosure, the robot 40 may directly block the vehicle C and stop the vehicle C, preventing direct collision between the pedestrian and the vehicle C. As an exemplary embodiment of the present disclosure, the robot 40 may block the vehicle C so that the vehicle C changes its course. In the instant case, the third separation distance may be smaller than the second separation distance.

The controller 50 may be electrically connected to the sensor device 10, the first warning device 20, the second warning device 30, and the robot 40, and may be provided to control the operations of the first warning device 20, the second warning device 30, and the robot 40.

The controller 50 may include a processor and a memory. The processor may include a microprocessor such as a field programmable gate array (FPGA), an application specific integrated circuit (ASIC), a central processing unit (CPU), or the like. The memory may store control instructions that are the basis for generating commands for determining whether to open or close the first warning device 20, the second warning device 30, or the robot 40 in the processor. The memory may be a data store such as a Hard Disk Drive (HDD), a solid state drive (SSD), volatile media, non-volatile media, or the like.

The controller 50 may perform machine learning. The controller 50 may perform machine learning on the operation of the robot 40. As the controller 50 performs machine learning on the operation of the robot 40, the robot 40 may ensure the safety of pedestrians through a more optimal behavior when an accident situation occurs.

Furthermore, the controller 50 may perform machine learning on the first separation distance, the second separation distance, the third separation distance, the first reference speed, and the second reference speed. The controller 50 may perform machine learning on the first separation distance, the second separation distance, the third separation distance, the first reference speed, and the second reference speed to reset the optimal separation distance or the reference speed to reduce the occurrence of accident situations.

Meanwhile, the crosswalk safety system may further include a traffic light SL. Hereinafter, for convenience of explanation, the direction in which the crosswalk R2 faces the roadway R1 is referred to as an external direction D1, and the direction in which the crosswalk R2 extends is referred to as an extension direction D2. The traffic light SL may be arranged in the external direction D1 of the crosswalk R2 to transmit a traffic signal to the vehicle C.

The sensor device 10 may be coupled to the traffic light SL. The sensor device 10 coupled to the traffic light SL may obtain information related to the speed of the vehicle C traveling on the roadway R1 located in the external direction D1 of the crosswalk R2.

The plurality of traffic lights SL may be formed and each may be arranged adjacent to an end portion of the crosswalk R2 in the extension direction D2. For example, as shown in FIG. 1, the traffic light SL may be located on the side opposite to the travelling direction of the vehicle C among the end portions of the crosswalk R2 in the extension direction D2.

The sensor device 10 may be coupled to the plurality of traffic lights SL, respectively. The controller 50 may be coupled to one of the plurality of traffic lights SL. This may mean that the controller 50 can control the plurality of sensor devices 10.

Hereinafter, an example of each warning device will be described in detail. The warning devices below are just examples, and various modifications may be possible, such as changing the type of the first warning device 20 and the shape of the second warning device 30.

The first warning device 20 may include a light source member 21. The light source member 21 may emit light to provide a primary warning to the vehicle C. A user who sees the light emitted from the light source member 21 may recognize that the crosswalk R2 is adjacent to and slow down the vehicle C. When the separation distance between the vehicle C and the crosswalk R2 is the first separation distance, and the speed obtained through the sensor device 10 is higher than or equal to the first reference speed, the controller 50 may turn on the light source member 21 to issue the primary warning.

As an exemplary embodiment of the present disclosure, the plurality of light source members 21 may be provided and arranged along the extension direction D2 in the external direction D1 of the crosswalk R2. For example, the plurality of light source members 21 are a plurality of LEDs.

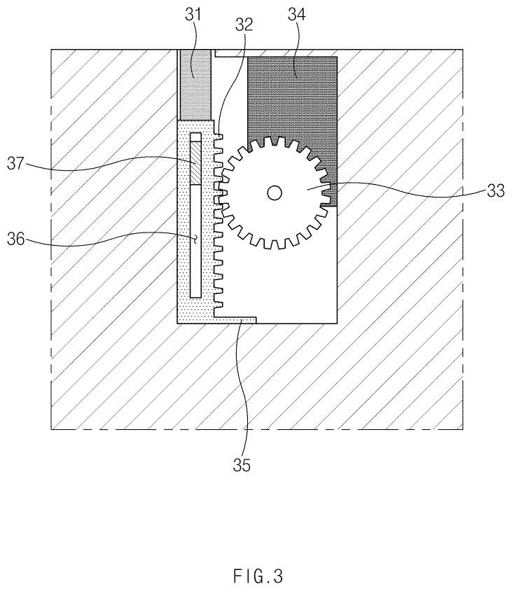

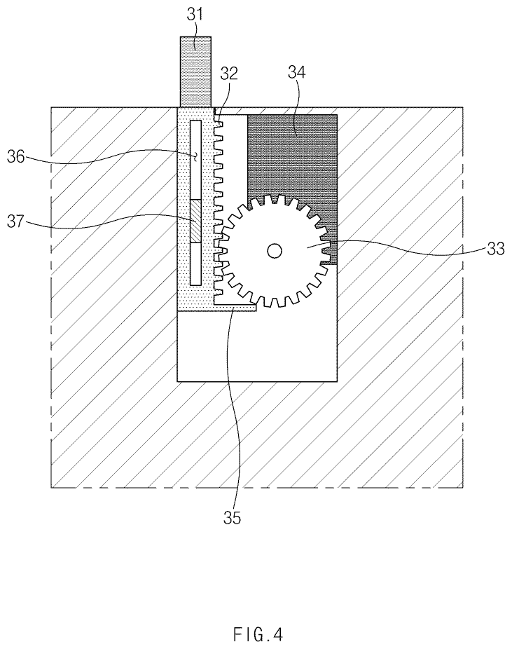

FIG. 3 is a diagram conceptually illustrating a second warning device. FIG. 4 is a diagram illustrating a bollard member protruding upward in FIG. 3.

The second warning device 30 may include a bollard member 31. The bollard member 31 may be provided to protrude upwards from the ground. The bollard member 31 may protrude upwards from the ground to make contact with the vehicle C, physically providing a secondary warning to the driver. Furthermore, the bollard member 31 may also have the effect of slowing down the vehicle C.

When the separation distance between the vehicle C and the crosswalk R2 is the second separation distance, and the speed obtained through the sensor device 10 is higher than or equal to the second reference speed, the controller 50 may allow the bollard member 31 to protrude upwards from the ground to issue the secondary warning.

A plurality of bollard members 31 may be formed and arranged along the extension direction D2 on one side of the crosswalk R2 in the external direction D1. Furthermore, the bollard member 31 may be arranged in the external direction D1 of the light source member 21. Meanwhile, the traffic light SL may be arranged in the external direction D1 of the bollard member 31.

Hereinafter, the structure for vertical movement of the bollard member 31 will be described in detail. The second warning device 30 may further include a rack 32, a pinion 33, and a motor 34. The rack 32 may be connected to a lower side of the bollard member 31. The pinion 33 may be arranged to engage with the rack 32, and move the rack 32 up or down as the pinion 33 rotates. The motor 34 connected to the pinion 33 may rotate the pinion 33. The controller 50 may be electrically connected to the motor 34 and may operate the motor to move the rack 32 up or down, moving the bollard member 31 up or down. In the instant case, the rack 32, pinion 33, and motor 34 may be composed of one set and connected to a plurality of bollard members, and may be configured to correspond to the number of bollard members 31 and connected to each bollard member 31.

The second warning device 30 may further include a stopper 35. The stopper may protrude from the lower end portion of the rack 32 toward the pinion 33. When the rack 32 is raised above a predetermined position, the stopper 35 may engage with the pinion 33 to prevent the rotation of the pinion.

A guide hole 36 extending in the vertical direction may be formed in the rack 32. The second warning device 30 may further include a guide 37. The guide 37 may be inserted into the guide hole 36 to guide the vertical movement of the rack 32.

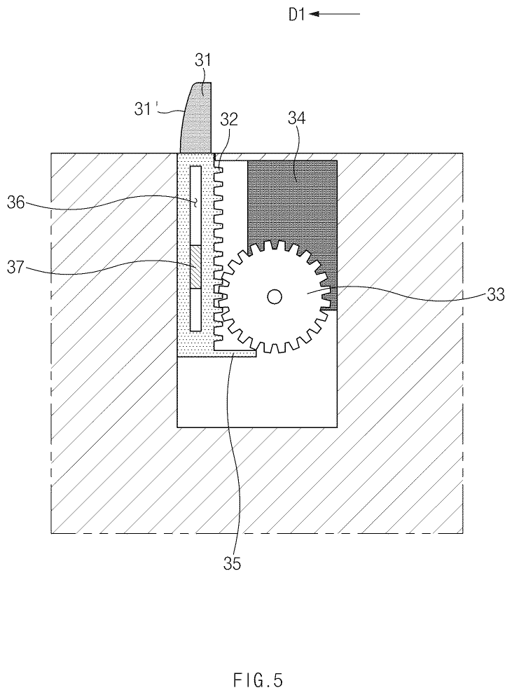

FIG. 5 is a diagram conceptually illustrating another example of the second warning device. As another example of the second warning device 30, the external direction D1 surface of the bollard member 31 may include a curved area 31′. The curved area 31′ is formed on the external direction D1 surface of the bollard member 31 and may be convex or concave toward the external direction D1. In FIG. 5, the curved area 31′ is shown including a convex shape toward the external direction D1.

Because the bollard member 31 includes the curved area 31′, when the wheel of the vehicle C collides with the bollard member 31, the curved area 31′ may guide the wheel along the curved surface. Compared to the case where the bollard member 31 is in a form of a bar, the problem of damage to the wheel of the vehicle C or bollard member 31 may be reduced.

The robot 40 may be placed in a robot movement area R3, which is an area between the crosswalk R2 and the light source member 21. When a pedestrian enters the crosswalk R2 and the secondary warning is not issued, the robot 40 may move along the pedestrian's movement direction in the external direction D1 of the pedestrian. This may be understood as a situation in which the robot 40 escorts pedestrians.

For example, in a situation where a pedestrian enter the crosswalk R2 and the secondary warning is not issued, the robot 40 may move along the direction of movement of the pedestrian in the external direction D1 of the pedestrian while escorting them. In the instant case, the robot 40 may assist the movement of a pedestrian through voice guidance, and the like.

When a request from a pedestrian is received, the robot may audio-visually transmit vehicle approach information to the pedestrian. Thus, the pedestrian may feel psychological stability while crossing the road.

After the secondary warning, the robot 40 placed in the robot movement area R3 may move toward the crosswalk R2 when the separation distance between the vehicle C and the crosswalk R2 obtained through the sensor device 10 is equal to or less than the third separation distance. While moving toward the crosswalk R2, the robot 40 may be placed between the vehicle C and the pedestrian to prevent the vehicle C from hitting the pedestrian.

Hereinafter, the operating sequence of the crosswalk safety system according to an exemplary embodiment of the present disclosure will be described in detail based on the above-mentioned contents.

First, the sensor device 10 continuously obtains information related to the speed of the vehicle C on the roadway R1 and the separation distance between the vehicle C and the crosswalk R2.

First, when the separation distance between the vehicle C and the crosswalk R2 is the first separation distance and the speed obtained through the sensor device 10 is greater than or equal to the first reference speed, the controller 50 turns on the light source member 21 to provide the primary warning to the driver of the vehicle C. The light emitted from the light source member 21 may reach the driver and induce the driver to slow down.

Next, after the primary warning, when the separation distance between the vehicle C and the crosswalk R2 is the second separation distance and the speed obtained through the sensor device 10 is greater than or equal to the second reference speed, the controller 50 may operate the motor 34 to move the bollard member 31 upward. As the bollard member 31 is in direct contact with the wheels of the vehicle C, some physical shock may be applied to the vehicle C to induce deceleration of the driver, and may also induce direct deceleration of the vehicle C due to collision.

Next, after the secondary warning, when the separation distance between the vehicle C and the crosswalk R2 obtained through the sensor device 10 is less than or equal to the third separation distance, the controller 50 may allow the robot 40 to move between a pedestrian crossing the crosswalk R2 and the vehicles C. The robot 40 may prevent direct collisions between the pedestrian and the vehicle C in an optimal scheme learned through machine learning.

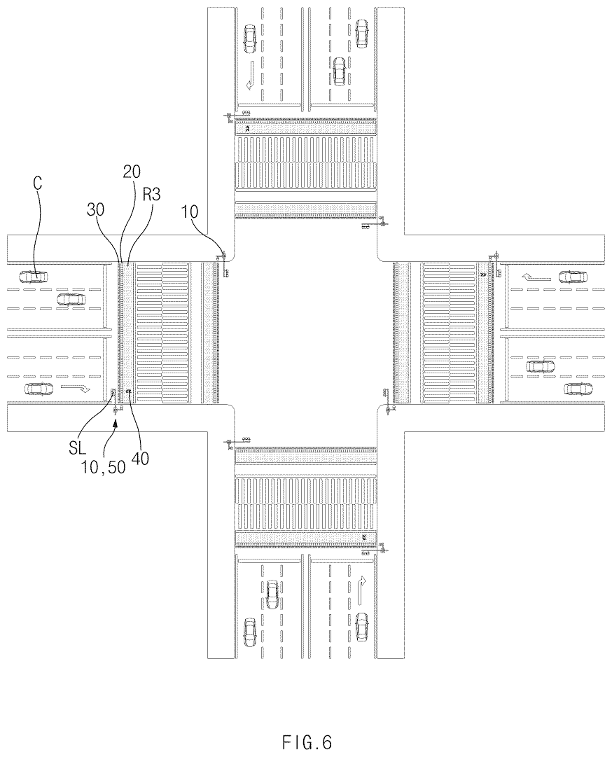

FIG. 6 is a diagram illustrating an intersection to which a crosswalk safety system according to an exemplary embodiment of the present disclosure is applied. As shown in FIG. 6, the above-described crosswalk safety system may also be applied to each intersection. In the instant case, the controller 50 may operate the first warning device 20, the second warning device 30, and the robot 40 based on the information obtained through the sensor device 10 arranged on each road.

According to an exemplary embodiment of the present disclosure, a warning may be transmitted to a driver through various schemes based on collected data, so that the occurrence of traffic accidents may be reduced.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A crosswalk safety system comprising:
a sensor device configured to obtain information related to a speed of a vehicle approaching a crosswalk through a roadway and a separation distance between the vehicle and the crosswalk;
a first warning device configured to issue a first warning to the vehicle in response that the speed obtained through the sensor device is equal to or greater than a first reference speed and the separation distance between the vehicle and the crosswalk is a first separation distance;
a second warning device configured to issue a second warning to the vehicle in response that the speed obtained through the sensor device is equal to or greater than a second reference speed and the separation distance between the vehicle and the crosswalk is a second separation distance after issuing the first warning;
a robot arranged to move between the vehicle and a pedestrian crossing the crosswalk in response that the separation distance between the vehicle and the crosswalk obtained through the sensor device is less than or equal to a third separation distance after issuing the second warning; and
a controller electrically connected to the sensor device, the first warning device, the second warning device, and the robot to control operations of the first warning device, the second warning device, and the robot.

2. The crosswalk safety system of claim 1, wherein the sensor device includes a Light Detection and Ranging (LiDAR) sensor.

3. The crosswalk safety system of claim 2, further including:
a traffic light arranged in an external direction of the crosswalk to transmit a traffic signal to vehicles in a state that a direction in which the crosswalk faces the roadway is the external direction,
wherein the sensor device is coupled to the traffic light.

4. The crosswalk safety system of claim 3,
wherein the traffic light includes a plurality of traffic lights, each of which is arranged adjacent to an end portion of the crosswalk in an extension direction in a state that a direction in which the crosswalk extends is the extension direction,
wherein the sensor device is coupled to each of the traffic lights, and
wherein the controller is coupled to at least one of the plurality of traffic lights.

5. The crosswalk safety system of claim 1, wherein the first warning device includes a light source member that emits light to provide the first warning to the vehicle.

6. The crosswalk safety system of claim 5, wherein the light source member includes a plurality of light source members arranged along an extension direction in an external diction of the crosswalk in a state that a direction in which the crosswalk faces the roadway is the external direction and a direction in which the crosswalk extends is the extension direction.

7. The crosswalk safety system of claim 1, wherein the second warning device includes a bollard member that is configured to protrude upwards from a ground.

8. The crosswalk safety system of claim 7, wherein the bollard member includes a plurality of bollard members arranged along an extension direction in an external diction of the crosswalk in a state that a direction in which the crosswalk faces the roadway is the external direction and a direction in which the crosswalk extends is the extension direction,

9. The crosswalk safety system of claim 8,
wherein the first warning device includes a light source member that emits light to issue the first warning to the vehicle,
wherein the light source member includes a plurality of light source member arranged along the extension direction in the external direction of the crosswalk, and
wherein the bollard member is arranged in the external direction of the light source member.

10. The crosswalk safety system of claim 7, further including:
a traffic light installed in an external direction of the crosswalk to transmit a traffic signal to vehicles,
wherein the traffic light is arranged in the external direction of the bollard member.

11. The crosswalk safety system of claim 7, wherein the second warning device includes:
a rack connected to a lower side of the bollard member;
a pinion engaged with the rack to move the rack up or down as the pinion rotates; and
a motor operatively connected to the controller and connected to the pinion and configured to rotate the pinion.

12. The crosswalk safety system of claim 11, wherein the second warning device further includes a stopper that protrudes from a lower end portion of the rack toward the pinion so that the stopper limits movement of the rack within a predetermined distance.

13. The crosswalk safety system of claim 12, wherein the stopper selectively engages with the pinion to prevent the rotation of the pinion.

14. The crosswalk safety system of claim 11,
wherein the rack includes a guide hole extending in a longitudinal direction of the rack, and
wherein the second warning device further includes a guide inserted into the guide hole to guide a vertical movement of the rack.

15. The crosswalk safety system of claim 7, wherein a surface of the bollard member in an external direction includes a curved area which is convex or concave toward the external direction in a state that a direction in which the crosswalk faces the roadway is the external direction.

16. The crosswalk safety system of claim 9, wherein the robot is arranged in a robot movement area which is defined between the crosswalk and the light source member.

17. The crosswalk safety system of claim 16, wherein the robot moves along a movement direction of the pedestrian in the external direction of the pedestrian in a state that the pedestrian enters the crosswalk and the second warning is not issued.

18. A method of controlling a crosswalk safety system, the method comprising:
obtaining, by a controller, information related to a speed of a vehicle approaching a crosswalk through a roadway and a separation distance between the vehicle and the crosswalk;
issuing, by the controller, a first warning to the vehicle in response that the speed of the vehicle is equal to or greater than a first reference speed and the separation distance between the vehicle and the crosswalk is a first separation distance;
issuing, by the controller, a second warning to the vehicle in response that the speed of the vehicle is equal to or greater than a second reference speed lower than the first reference speed and the separation distance between the vehicle and the crosswalk is a second separation distance shorter than the first separation distance after issuing the first warning; and
controlling, by the controller, a robot of the crosswalk safety system, to move between the vehicle and a pedestrian crossing the crosswalk in response that the separation distance between the vehicle and the crosswalk is less than or equal to a third separation distance shorter than the second separation distance after issuing the second warning.

19. The method of claim 18, further including:
controlling, by the controller, the robot to move along a movement direction of the pedestrian in an external direction of the pedestrian in a state that the pedestrian enters the crosswalk and the second warning is not issued.
